(19) United States
(12) Patent Application Publication
(10) Pub. No.: US 2008/0010839 A1
(43) Pub. Date: Jan. 17, 2008

(54) Handheld rotary cutter

(75) Inventors: David C. Eby, Madison, WI (US); Luc Lam, Madison, WI (US); James C. Boda, Merrimac, WI (US); Robert Schofield, Brooklyn, WI (US); Christine Dusk, Blanchardville, WI (US)

Correspondence Address: FOLEY & LARDNER LLP, 321 NORTH CLARK STREET, SUITE 2800, CHICAGO, IL, 60610-4764, US

(73) Assignee: Fiskars Brands, Inc.

(21) Appl. No.: 11/486,260

(22) Filed: Jul. 13, 2006

(51) Int. Cl. B26B 3/00

(52) U.S. Cl. 30/319

(57) ABSTRACT

A rotary cutter, comprising a body, a trigger and an actuator member. The body includes a rear end and a forward end, the forward end including a cylindrical head. The trigger is rotatably connected at one end thereof to the rear end of the body, and the actuator member is also rotatably connected to the body. The actuator member is in at least selective contact with the trigger such that rotation of the trigger results in a reciprocal rotation of the actuator member. A blade assembly is removably coupled to the actuator member and is configured to move between a retracted position and an extended position. Actuation of the trigger results in the blade assembly moving towards the extended position. When the blade assembly is in the extended position, the blade assembly is capable of contacting a cutting surface.

### FIELD OF THE INVENTION

The present invention relates generally to rotary cutters. More particularly, the present invention relates to handheld rotary cutters for cutting materials such as fabric, cardboard, paper or other materials.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Handheld rotary cutters are commonly used to cut layers of fabric, cardboard, paper, vellum or other materials. Rotary cutters typically include a body with a handle attached thereto for gripping by a user. A generally circular head includes a surface to which a substantially circular cutting blade is attached. This type of rotary cutter is discussed in, for example, U.S. Pat. No. 4,432,137, issued to Okada, U.S. Pat. No. 6,189,218, also issued to Okada, and U.S. Pat. No. 5,765,289, issued to Schulz et al. In some such cutters, when a user actuates a lever or gripping surface on the rotary cutter, the cutting blade is extended away from the surface and is exposed for use.

Although such rotary cutters are useful and serve a variety of purposes, they also suffer from a number of shortcomings. For example, every time that a user wishes to extend the cutting blade, he or she must grip the lever with enough force to cause the appropriate displacement in the cutting blade. Many rotary cutters are designed such that the user must exert a force around the center or towards the back of the lever to actuate the cutting blade. In this configuration, the upward movement of the rear portion of the lever causes a corresponding downward movement in the actuator component which connects to the cutting blade. However, in this arrangement, the center of the lever is relatively far towards the pinky finger of the user's hand, where he or she possesses a relatively low amount of strength and control relative to the opposite end of the hand.

Alternatively, some rotary cutters attempt to address this issue by altering the internal mechanical connections of the rotary cutter such that the force must be exerted in the area of the user's fingers of greatest length. However, as this point moves towards the front of the lever and closer to the cutting blade itself, there is less mechanical advantage provided to the user, thereby requiring the user to exert more force in order to successfully extend the cutting blade. Over time, this will cause muscle fatigue to the user, and the user will therefore not be able to use the cutting effectively for long periods of time. This problem can be acute with elderly users and others who may not be capable of repeatedly exerting significant amounts of force on the lever.

Furthermore, when a user is cutting a piece of material resting on a flat surface, many rotary cutters are arranged such that the forces provided against the cutting blade by the flat surface ultimately are exerted against some or all of the user's hand. This arrangement greatly affects the user's comfort level and can cause strains and other ailments over time.

It would therefore be desirable to provide a handheld rotary cutter which addresses the shortcomings and provides the user with the ability to effectively use the device for extended periods of time without having to rest.

### SUMMARY OF THE INVENTION

Various embodiments of the present invention provide for an improved rotary cutter comprising a trigger which is operatively connected to a blade actuator. The blade actuator is configured to have a cutting blade removably coupled thereto. The blade actuator includes an actuator pin which slidably engages a guide structure of the trigger. When the user applies force near the front of the trigger, force is transmitted to the blade actuator via a pin and guide structure. At the same time, the blade actuator rotates relative to the trigger via the movement of the actuator pin within the guide structure. As a result, the rotation of the blade actuation causes a downward movement in the operatively connected cutting blade.

The embodiments of the present invention provide for a number of advantages over conventional rotary cutters. As a result of the linkage configuration of the trigger and the blade actuator, when a user is cutting a piece of material resting on a surface such as a cutting mat, the forces exerted on the cutting blade from the cutting mat are directed past the user's hand and to the rear pivot point of the trigger. This increases the user's comfort level over prolonged periods of use and allows for an improved ergonomic design. In addition to the above, the rotary cutter of the present invention is also designed for mass production, while accommodating multiple manufacturing processes abd assembly processes.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a sectional side view of a handheld rotary cutter constructed in accordance with one embodiment of the present invention, with the blade actuator in a retracted position;

FIG. 2 is a sectional side view of the handheld rotary cutter of FIG. 1, with the blade actuator in an extended position; and

FIG. 3 is an exploded view showing the components of the rotary cutter of FIGS. 1 and 2.

### DETAILED DESCRIPTION OF THE PREFERRED EMBODIMENTS

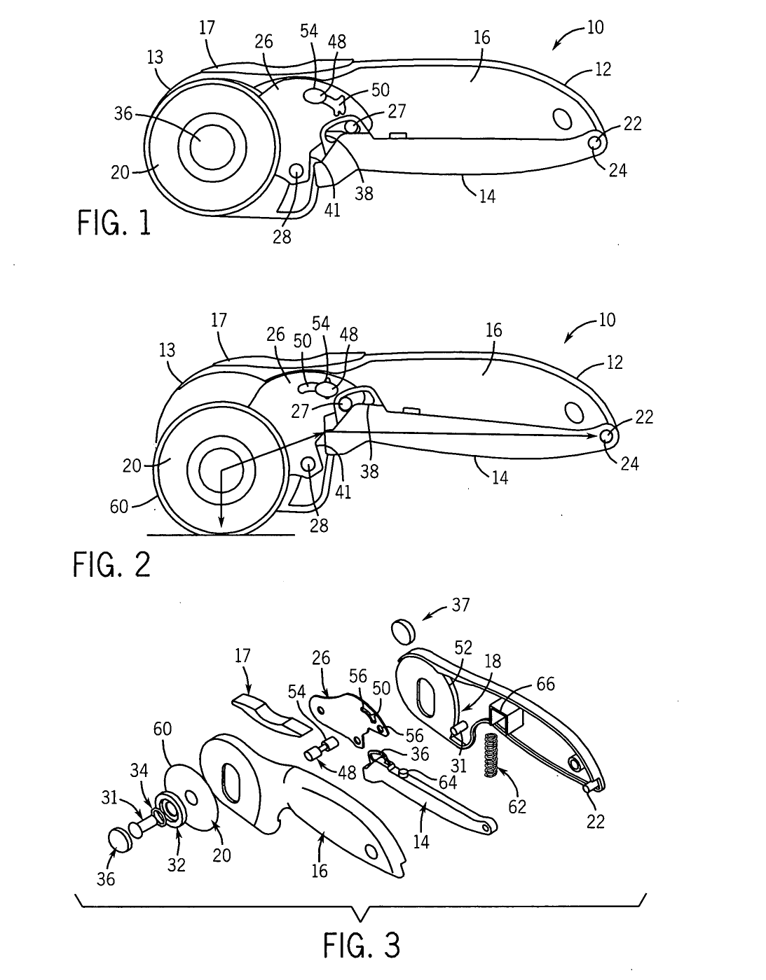

FIGS. 1-3 show a rotary cutter 10 constructed in accordance with the principles of the present invention. The rotary cutter 10 includes a body 12 having a cylindrical head 13. The body 12 can take a variety of forms. For example, the body 12 can include separable but substantially identical right and left handles 16 and 18 which can either surround or both be on one side of a cutting blade 20 and be joined in part by a handle insert 17. Other arrangements and configurations of the body 12 would also be understood to be potentially implemented by those skilled in the art.

A trigger 14 is rotatably coupled to the body 12 at a rearward pivot point 22. In the embodiment shown in FIGS. 1-3, this is accomplished by using a plastic or metallic rearward pivot pin 24 to couple the trigger 14 to the body 12.

In addition to the trigger 14, a blade actuator 26 is also rotatably coupled to the body 12. As shown in FIGS. 1 and 2, the blade actuator 26 is coupled to the body 12 at a forward pivot point 28, using a plastic or metallic forward pivot pin 30 in various embodiments of the invention. The blade actuator 26 also includes a region to which the cutting blade 20 is attached. The cutting blade 20 can be placed on a blade axle 31 removably connected to the blade actuator 26, and a hub cup 32, wave spring 34 and hub cap 36 can cooperatively be used to selectively secure the cutting blade 20 in place. In the embodiment shown in FIGS. 1-3, a nut 37 is positioned within the body 12 and is used to tighten the blade axle 31 so that the cutting blade 20 remains secured to the body 12. The rotary cutter 10 can be sized for various cutting blades, including but not limited to 45 mm and 60 mm blades.

As shown in FIGS. 1 and 2, the trigger 14 and the blade actuator 26 interact as follows. An actuator pin 27 slidably engages a guide structure 38 formed on the trigger 14. In this particular embodiment of the invention, the guide structure 38 comprises a slot within which an actuator pin 27 moves. It is also possible, however, for the guide structure 38 to take other forms. The guide structure 38 is located at an end of the trigger 14 substantially opposite the rearward pivot point 22. The actuator pin 27 can either be formed as part of the blade actuator 26, or it could be a separate component which is coupled to the blade actuator 26. When the end of the trigger 14 closest to the cutting blade 20 (the forward end) moves towards the top of the rotary cutter 10 (i.e., when the trigger 14 rotates in a clockwise direction in FIGS. 1 and 2), the guide structure 38 “pushes” the actuator pin 27 upwards as well. As a result, movement of the trigger 14 causes a reciprocal movement in the blade actuator 26 (i.e., the blade actuator 26 moves in a counter-clockwise direction in FIGS. I and 2).

The operation of the rotary cutter 10 is generally as follows. FIG. 1 shows the rotary cutter 10 in a “retracted” position, with the cutting blade 20 retracted and its edge 60 not exposed. To extend the cutting blade 20, the user grasps the trigger 14, pulling the trigger 14 upwards towards the top of the rotary cutter 10. This action causes the guide structure 38 of the trigger 14 to act against the actuator pin 27, causing the rear portion of the blade actuator 26 to also move upward. This results (in terms of FIGS. 1 and 2) in a counter-clockwise rotation of the blade actuator 26 about the forward pivot point 28, causing the forward portion of the blade actuator 26 to move downward. As the cutting blade 20 is coupled to the forward portion of the blade actuator 26, the cutting blade 20 also moves downward in response to this action. As a result, the cutting blade edge 60 becomes exposed (as represented in FIG. 2), allowing a user to cut materials as necessary using the cutting blade 20. When the cutting action is taking place, the forces applied to the rotary cutter 10 from the cutting surface, such as a cutting mat, are transferred from the blade actuator 26 to the trigger 14 where the blade actuator 26 contacts a trigger finger 41. These forces are ultimately transferred to the rearward pivot point 22 and do not bear directly against the user's hand.

When a user wishes to retract the cutting blade 20, the user simply loosens his or her grip on the trigger 14. The relieving of force on the trigger 14 allows a biasing member 62, a compression spring in one embodiment of the invention, to bias the trigger 14 away from the upper surface of the body 12. The biasing member 62 is configured to contact a biasing abutment 64 on the trigger 14 and a upper biasing surface 66 on the body 12. Once the user's grip on the trigger 14 has been released, the rotary cutter 10 returns to the retracted position shown in FIG. 1.

In addition to the above, a locking member 48 can be used to selectively lock the cutting blade 20 in a certain position. As is shown in FIGS. 1-3, the blade actuator 26 includes a locking region 50 that is sized to interact with the locking member 48, which also fits within a locking member receptacle 52 of the body 12. As is most clearly shown in FIG. 3, the locking member 48, according to one embodiment of the invention, includes an abutment 54 which is sized to selectively match a pair of abutment openings 56 in the locking region 50. In the embodiment depicted in FIGS. 1-3, the user can press the locking member 48 from either side of the body 12 to move the abutment 54 into and/or out of engagement with one of the abutment openings 56, selectively locking and unlocking the position of the blade actuator 26 and therefore the cutting blade 20. By using the locking member 48, the user obtains the added benefit of not having to keep applying force to the trigger 14 to keep the cutting blade 20 in an extended position. The locking member also adds to the overall stability of the rotary cutter 10, as the likelihood of the cutting blade 20 moving during a cutting operation is greatly reduced.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A rotary cutter, comprising:
a body having a rear end and a forward end, the forward end including a cylindrical head;
a trigger rotatably connected at one end thereof to the rear end of the body;
an actuator member rotatably connected to the body and being in at least selective contact with the trigger such that rotation of the trigger results in a reciprocal rotation of the actuator member; and
a blade assembly removably coupled to the actuator member, the blade assembly configured to move between a retracted position and extended position,
wherein actuation of the trigger results in the blade assembly moving towards the extended position, and wherein when the blade assembly is in the extended position, the blade assembly is capable of contacting a cutting surface.

2. The rotary cutter of claim 1, wherein the trigger is rotatably connected to the rear end of the body via a rear pivot pin, and wherein when the blade assembly contacts a cutting surface when in the extended position, forces imparted on the rotary cutter by the cutting surface are transferred to the rear pivot pin.

3. The rotary cutter of claim 1, wherein the actuator member is rotatably connected to the body at a forward pivot pin.

4. The rotary cutter of claim 1, further comprising a locking member configured to selectively engage the actuator member and move between an unlocked position and a locked position, wherein the actuator is impeded from moving when the locking member is in a locked position.

5. The rotary cutter of claim 1, wherein the trigger includes a guide path configured to engage an actuator pin operatively connected to the actuator member, and wherein movement of the trigger results in a corresponding movement of the guide path and the actuator pin.

6. The rotary cutter of claim 5, wherein the guide path comprises a slot formed in an upper portion of the trigger, and wherein the actuator pin is positioned within the slot.

7. The rotary cutter of claim 1, wherein the blade assembly comprises:
a rotary cutting blade; and
an axle operatively connected to the actuator member and the rotary cutting blade.

8. The rotary cutter of claim 1, wherein the body comprises:
a first body portion;
a second body portion coupled to the first body portion; and
a handle insert coupling the first body portion to the second body portion.

9. The rotary cutter of claim 1, further comprising a biasing member in operative engagement with the trigger, wherein the biasing member acts against the trigger to bias the trigger in a direction to move the blade assembly towards the retracted position.

10. A rotary cutter, comprising:
a body having a rear end and a forward end, the body including a forward pivot pin and a rearward pivot pin;
a trigger rotatably connected to the rear end of the body via the rearward pivot pin;
an actuator member rotatably connected to the body via the forward pivot pin and being in at least selective contact with the trigger such that rotation of the trigger results in a reciprocal rotation of the actuator member; and
a blade assembly removably coupled to the actuator member, the blade assembly configured to move between a retracted position and extended position,
wherein actuation of the trigger results in the blade assembly moving towards the extended position, and wherein when the blade assembly is in the extended position, the blade assembly is capable of contacting a cutting surface.

11. The rotary cutter of claim 10, further comprising a locking member configured to selectively engage the actuator member and move between an unlocked position and a locked position, wherein the actuator is impeded from moving when the locking member is in a locked position.

12. The rotary cutter of claim 10, wherein the trigger includes a guide path configured to engage an actuator pin operatively connected to the actuator member, and wherein movement of the trigger results in a corresponding movement of the guide path and the actuator pin.

13. The rotary cutter of claim 12, wherein the guide path comprises a slot formed in an upper portion of the trigger, and wherein the actuator pin is positioned within the slot.

14. The rotary cutter of claim 10, wherein the blade assembly comprises:
a rotary cutting blade; and
an axle operatively connected to the actuator member and the rotary cutting blade.

15. The rotary cutter of claim 10, wherein the body comprises:
a first body portion;
a second body portion coupled to the first body portion; and
a handle insert coupling the first body portion to the second body portion.

16. The rotary cutter of claim 15, wherein the forward pivot pin and the rearward pivot pin are each formed in one of the first body portion and the second body portion.

17. The rotary cutter of claim 10, further comprising a biasing member in operative engagement with the trigger, wherein the biasing member acts against the trigger to bias the trigger in a direction to move the blade assembly towards the retracted position.

18. The rotary cutter of claim 17, wherein the biasing member comprises a compression spring, and wherein the compression spring engages a biasing abutment on the trigger.
